(19) United States
(12) Patent Application Publication
(10) Pub. No.: US 2006/0157570 A1
(43) Pub. Date: Jul. 20, 2006

(54) Card armor

(76) Inventor: Frederick Day, Margate, NJ (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/318,287

(22) Filed: Dec. 23, 2005

Related U.S. Application Data
(60) Provisional application No. 60/640,149, filed on Dec. 29, 2004.

(51) Int. Cl. G06K 19/00

(52) U.S. Cl. 235/487

(57) ABSTRACT

A backing to reinforce and protect a card. The backing can adhesively attach to a card, such as a credit card or a keycard. Thus, a hole can be punched through the card and through the backing, thus providing a more sturdy card which is less susceptible to breaking.

### CLAIM OF PRIORITY

This Application claims benefit to provisional application 60/640,149, filed on Dec. 29, 2004, entitled “Card Armor,” which is incorporated herein by reference in its entirety.

### FIELD OF THE INVENTION

The present invention is directed to the field of security cards. In particular, the present invention is directed to the area of security cards that are attached with adhesive to the card key after encoding.

### BACKGROUND OF THE INVENTION

There have been a number of inventions directed to the area of card production. U.S. Pat. No. 6,245,382 discloses a protective film which includes a base film, a release layer, a protective layer and an adhesive layer. The protective layer is formed using a curable composition. The invention is also directed towards methods of making the protective film of the invention. According to one embodiment of the invention, the protective film is made using a one-step curing process. In an alternate embodiment, the protective film of the invention is formed using a two-step curing process. The invention is also directed towards a method of making a protected data carrying device. According to the invention, the protected data carrying device includes a polymeric substrate and a protective coating. Optionally, the protected data carrying device can include more than one layer of the protective coating. The invention is also directed towards a protected data carrying device which includes a polymeric substrate and the protective coating of the invention.

U.S. Pat. No. 4,938,830 is directed to a method of fabricating a plastic card including the steps of printing on the rear surface thereof, laminating a sheet of clear plastic to the rear surface while simultaneously polishing the front surface, laminating a metal layer to the front surface of the sheet of plastic, and applying a protective coating of a mixture of aminocoumarin dye and clear liquid polyvinyl chloride to the surface by a silk screen process to thereby protect the metal layer against wear and abrasion. A plastic card including a central layer having a front surface and a rear surface, a layer of clear plastic sheeting on the rear surface, a metalized layer on the front surface, and a coating of cured silk-screen-applied clear liquid resin consisting of a mixture of aminocoumarin dye and clear liquid polyvinyl chloride on the metal layer for protecting it against wear and abrasion.

U.S. Pat. No. 4,736,966 is directed to an optical data storage medium, such as a data card with a strip of optical data storage material, having peelable transparent protective layers adhered above the storage material. When a protective layer becomes too scratched to read or write through, it may be removed by peeling. More than one layer may be adhered successively above one another, and removed one by one as they become scratched. The peelable protective layers are preferably adhesive tapes made of Aclar, Mylar, polyester, or other hard-to-tear polymers with pressure sensitive adhesive. One or more of the layers, and an underlayer between substrate or card base and the storage material may be a water barrier material such as a polytrichlorofluoroethylene.

U.S. Pat. No. 5,746,451 discloses an overlay for the front surfaces of credit, debit, ATM and similar transaction cards. The overlay is designed in such a manner that it allows the cardholder to customize the appearance of the front surface of the cardholder's cards without affecting the operability of the card. The overlay of the present invention may be easily fabricated with a number of designs, ranging from artistic designs, to personal photographs, to political, religious, humorous, or other messages. As such, the present invention allows a cardholder to customize and personalize the appearance of the cardholder's cards as well as to use the cards as a means to communicate ideas and messages in addition to acting as a means of payment whenever a card is used.

U.S. Pat. No. 5,350,209 discloses a card package assembly and method of manufacture thereof allow simple and inexpensive production of desirable products, particularly useful for telephone debit cards. A web of card stock is imaged on both first and second faces with indicia (preferably variable and non-variable), and the faces are spot coated with plastic at spaced locations equal to the length of card package ultimately separated from the web. A card is formed from or out of each of the spot coated plastic locations, by die cutting, or with lines of weakness such as perforations. The form is narrower at the card, and adhesive patterns outside the card portions hold other panels of the package together once folded over to sandwich the card between other panels. The cards may be produced from a web one package wide, or from a web two or even more packages wide. A bang tail is preferably provided connected to the card, and of the same width, with a perforation separating the bang tail from the card and coupon indicia imaged on the bang tail.

U.S. Pat. No. 5,844,230 discloses an improved information card having a plurality of information sets on a single, single piece card. The information card is in one preferred embodiment a single, single piece, plate member which is operable to contain two discrete sets of embossed information such as for two credit card accounts, each on a separate section of one side of the card. The information card also preferably includes two magnetic strips on the reverse side of the card, which may preferably correspond to the two sets of embossed information. In the method of the present invention, a conventional sized plate member is embossed to form two discrete information sections, with the indentations in the rear of the embossed characters optionally filled with a suitable compound before affixing two magnetic strips on the reverse side of the plastic member. In an alternative embodiment, the information card is a composite of two bonded plate members, each having an embossed section and a magnetic strip. An alternative method utilizes two plate members, each member embossed on one side. A magnetic strip is affixed to the same side as the embossed characters, and the two plate members are thereafter adhesively bonded to form a composite information card. In yet another alternative embodiment, the information card is made from two plate members laminated together, each plate member having one or more magnetic strips located on one side, with a plurality of alphanumeric characters embossed directly over each magnetic strip. In yet another alternative embodiment, the information card and method for making includes sets of oppositely embossed projections upon a single plate member and corresponding magnetic strips on opposite sides of the plate member.

U.S. Pat. No. 6,752,305 discloses a non-rigid identification card holder system which can be attached to a breakaway lanyard for holding the identification card about the neck, to a clip for attaching the identification card to an article of clothing, or to a band for securing the card about the arm or leg. The identification card holder comprises at least one pocket sized to hold the identification card. In a preferred embodiment, at least one face of the pocket comprises a transparent polymeric material to allow easy viewing of the card. Any information contained on electronic chips which may be part of the card can also be scanned through the transparent material. A reinforced hole may be provided in the pocket face through which a finger may be inserted to aid in removing the identification card from the pocket. In another preferred embodiment, the card holder has two back-to-back pockets with the outer face of each pocket comprising a window of transparent polymeric material. The identification card holder may also provide additional pockets sized to hold ATM cards, phone cards, credit cards, photographs, security cards etc. For improved durability, the identification card holder may be made of a second material such as a woven material or nylon in addition to the first transparent polymeric material.

U.S. Pat. No. 5,992,957 discloses an abrasion control apparatus allowing a drawer member of an electronic enclosure to be inserted into a receptacle wherein the contacting sides of the drawer member and receptacle are made of aluminized steel. The invention includes a double thick side of the receptacle; the side of the receptacle which comes in contact with the side of the drawer member having a window in which is placed a plastic wear strip. The abrasion control apparatus further includes wear strips in a notched portion of the side of the receptacle and a bottom of the receptacle such that contact is prevented between the drawer and the metal sides of the receptacle as the drawer member is inserted into the receptacle.

U.S. Pat. No. 5,058,926 discloses a two-element lamination product for manufacture of a secure identification card that requires no insert comprises first and second resin lamination sheets, each substantially larger than the desired ID card dimensions, that are joined along one edge; the two sheets have engageable heat-and-pressure sealable surfaces and are precision cut to define two aligned, matching card panels of the desired ID card dimensions. Each card panel is joined to its sheet by plural frangible bridges. The first card panel has a transparent portion and the second an aligned, matching opaque portion with an image-receptive surface facing the first card panel; opacity may be obtained by pigmentation or by surface coating. Usually, the entire first card panel is transparent and the second card panel is all opaque. After ID image data is applied to the opaque part of the second card panel the sheets are sealed together and the sealed card panels are then broken out, affording a secure ID card that is very difficult to separate for alteration purposes.

U.S. Pat. No. 4,469,353 discloses a protective lamination film for an identification card or other document, of the kind comprising a tough, abrasion-resistant transparent polyester film coated with polyethylene or other adhesive activatable by heat and pressure, has a multiplicity of slits cut into the film in a pattern that allows the film to hold together in normal use but causes the film to tear if any post-lamination alteration is attempted; the film may be employed as an outer cover for the document, or it may comprise separate film interposed between the document and a continuous film providing an external cover.

U.S. Pat. No. 6,699,128 discloses a removable processor enclosure apparatus for use in a gaming machine having a housing defining an interior portion, and a first electrical connector disposed in the interior portion. The enclosure apparatus includes an enclosure containing the CPU electrical components therein, and is adapted for sliding receipt in the interior portion of the gaming machine housing between a mounting condition and a removal condition. In the mounting condition, the enclosure is mounted to the housing and electrically coupling a second electrical connector of the enclosure to the first electrical connector of the housing. In the removal condition, the enclosure can be removed from the housing. A release device is interengaged between the housing and the enclosure, and is selectively movable between a first position, locking the enclosure in the mounting condition, and a second position, releasing the enclosure from the mounting condition to the removal condition and disconnecting the second electrical connector from the first electrical connector.

U.S. Pat. No. 5,935,673 discloses a device to protect the optical surface of optical disc information recording media such as a compact disc (CD) or a digital versatile disc (DVD), that surface is coated with a removable layer of a material that does not significantly alter the optical properties of the disc. Whenever the coating layer may have become damaged, it is removed and replaced with a new layer.

U.S. Pat. No. 6,575,371 discloses a method for producing injection-molded cards with at least one decorative layer (2, 6) which is already applied to a foil (1, 7) or an inlay before injection molding. To protect the inks used for the decoration from thermal action and/or excessive pressures and/or high mechanical stress during injection molding, the decorative layer (2, 6) is covered according to the invention with a protective layer (3, 5) before the foil (1, 7) provided with the decoration or an inlay provided with a decoration is inserted into the injection mold.

U.S. Pat. No. 5,331,139 to Lee, has an issue date of Jul. 19, 1994. The patent is directed to a card reader having an antiabrasion member for preventing a bottom surface of a card checking passage of the card reader from card contact abrasion. This antiabrasion member is easily inserted in a mold before an injection molding of a main body of the card reader and prevented from displacement in the mold, and allows a magnet head to be easily changed with new one to provide a good compatibility of the magnet head. The plurality of notches prevents the antiabrasion member from being horizontally displaced in a mold and are provided at both sides of the member, and engage with individual ribs of the mold when the member is located in the mold. The slit is provided as a result of lateral cutting of the member between the notches. The resilient part integrally extends from a side of the member near the slit and allows the slit to be inserted in a rib of the mold, and prevents the member from being vertically displaced in the mold.

### SUMMARY OF THE INVENTION

It is an object of the present invention to provide a protective mechanism for a card, such as a key card or credit card.

The above aspects can also be obtained by an apparatus that includes (a) a card; and (b) an adhesive backing attached to the card, (c) wherein the backing is slightly smaller in height and width than the card.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIGS. 1a and 1b are two embodiments of a card armor of the present invention.

### DESCRIPTION OF THE PREFERRED EMBODIMENTS

The invention will be utilized by any industry using a card key type lock device. This product protects the master card keys from premature plastic fatigue and fracture. The loss of master keys by service personal will require re-keying of all locks. This device can also be used to attach to casino slot payer cards and credit cards.

The armor will preferably comprise a protective backing, smaller in height and width than the respective card, which adhesively attaches to the card. Preferably it should not cover the magnetic strip on the card (if there is one) so that the card can be used while the backing is attached.

The product is preferably made of Kydex plastic. It can also be made of any other type of plastic or any other material as well with an adhesive surface allowing for easy application. The plastic will have a writable surface for labeling. The armor is adaptable to any type of card key lock (i.e. slide or insert). Card keys are 3¼×2⅛ inches. The armor is either 3⅛×¾ or 2×1 depending on the application. Thickness is standard, about 1 mm. A punch is use to create an orifice for an attachment leash. Refer to diagrams for specifics.

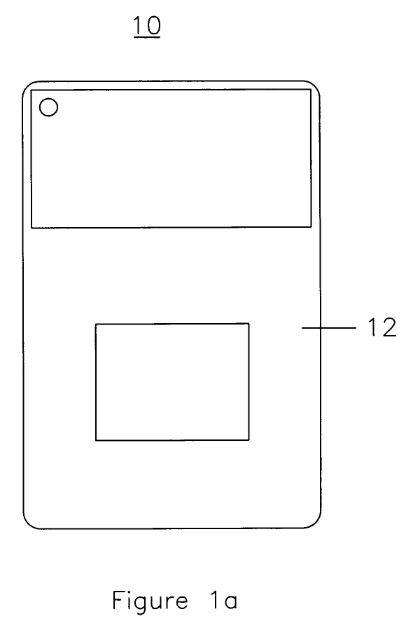

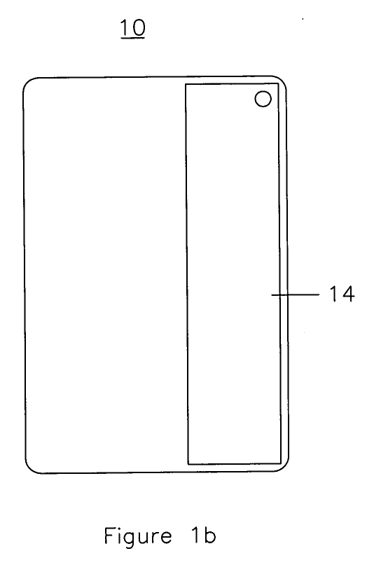

FIGS. 1a and 1b illustrate two embodiments of a card key armor 10. The first embodiment illustrates armor 12 attached to a card with an optional hole 12 punched in the upper left. A second embodiment illustrates armor 14 with a hole punched in the upper center. In both embodiments, the armor does not cover the magnetic stripping. The present invention is attached to any kind of card (e.g. a key card or a master key card, a credit card, a casino card, etc.).

The armor can be made of a plastic material (or any other material). The armor can be attached to the key card via an adhesive strip, or alternatively another attachment mechanism (glue, etc.). A hole punched through the armor can be used to tie a string or the like through so the armor can be hung. In this way, the armor provides reinforcement for the card. This can be especially important when a hole is punched through the card, as without the armor, the card may break easily. The armor also generally provides additional reinforcement and strength for the card and can help prevent bending and breakage.

A portion of the armor can also be writable. For example, an adhesive paper portion 16 can be attached to the armor so that someone can write onto the armor identification. Alternatively, the armor can be made of a material that is directly writable. The hole can be punched in the armor to allow a string or chain to be inserted. The armor (or a plurality of like armors) can be hung on any object, such as a key rack.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. A reinforced card apparatus, comprising:
a card; and
an adhesive backing attached to the card,
wherein the backing is slightly smaller in height and width than the card.

2. An apparatus as recited in claim 1, wherein a thickness of the backing is thicker than the card.

3. An apparatus as recited in claim 1, wherein a hole is punched through the backing and the card.

4. An apparatus as recited in claim 1, further comprising a writable area on the backing to provide a space to allow writing.

5. An apparatus as recited in claim 1, wherein a thickness of the backing is about 1 mm.

6. An apparatus as recited in claim 1, wherein the backing is made of plastic.
